(19) United States
(12) Patent Application Publication
(10) Pub. No.: US 2021/0004978 A1
(43) Pub. Date: Jan. 7, 2021

(54) METHOD FOR ACQUIRING DEPTH INFORMATION OF TARGET OBJECT AND MOVABLE PLATFORM

(71) Applicant: SZ DJI TECHNOLOGY CO., LTD., Shenzhen (CN)

(72) Inventors: Jie QIAN, Shenzhen (CN); Liliang ZHANG, Shenzhen (CN); Bo WU, Shenzhen (CN)

(21) Appl. No.: 17/027,358

(22) Filed: Sep. 21, 2020

Related U.S. Application Data
(63) Continuation of application No. PCT/CN2018/096636, filed on Jul. 23, 2018.

(51) Int. Cl. G06T 7/55; G06K 9/78; G06K 9/62; G06T 7/73; G06T 7/20; H04N 5/232

(52) U.S. Cl. CPC G06T 7/55; G06K 9/78; G06K 9/6202; H04N 5/247; G06T 7/20; H04N 5/23299; G06T 2207/10028; G06T 7/74

(57) ABSTRACT

A method for acquiring depth information of a target object and a movable platform are provided. A capturing device and a depth sensor are configured at a body of the movable platform. The method includes acquiring first region indication information of the target object, where the first region indication information is configured to indicate an image region of the target object in an image outputted by the capturing device; and acquiring the depth information of the target object from a depth image outputted by the depth sensor according to the first region indication information.

### CROSS-REFERENCE TO RELATED APPLICATION

This application is a continuation of International Application No. PCT/CN2018/096636, filed Jul. 23, 2018, the entire content of which is incorporated herein by reference.

### TECHNICAL FIELD

The present disclosure relates to the field of terminal technology and, more particularly, to a method for acquiring depth information of a target object, and a movable platform.

### BACKGROUND

Currently, a movable platform equipped with a capturing device may use a machine learning algorithm to identify a target object to be tracked in an image captured by the capturing device, thereby acquiring a bounding box of the target object in the image, and may determine a location of the target object according to the bounding box of the target object and also track the target object according to the location.

However, in practical applications, using the bounding box of the target object to determine the target object location may have low accuracy and reliability. When determining the location of the target object, it is much desirable to combine depth information of the target object with the bounding box to improve accuracy and reliability. Thus, there is a need to provide a method for acquiring the depth information of the target object.

### SUMMARY

In accordance with the disclosure, a method for acquiring depth information of a target object is provided in the present disclosure. The method includes acquiring first region indication information of the target object, where the first region indication information is configured to indicate an image region of the target object in an image outputted by the capturing device; and acquiring the depth information of the target object from a depth image outputted by the depth sensor according to the first region indication information.

Also in accordance with the disclosure, a movable platform is provided in the present disclosure. The movable platform includes a memory, a processor, a capturing device, and a depth sensor. The memory is configured to store program instructions. The processor for calling the program instructions is configured to acquire first region indication information of a target object, wherein the first region indication information is configured to indicate an image region of the target object in an image outputted by the capturing device; and the processor is further configured to, according to the first region indication information, acquire depth information of the target object from a depth image outputted by the depth sensor.

### BRIEF DESCRIPTION OF THE DRAWINGS

In order to more clearly illustrate technical solutions in embodiments of the present disclosure, drawings required for describing the embodiments are briefly illustrated hereinafter. The following drawings are merely examples for illustrative purposes according to various disclosed embodiments and are not intended to limit the scope of the present disclosure. Drawings incorporated in the specification and forming part of the specification demonstrate embodiments of the present disclosure and, together with the specification, describe the principles of the present disclosure.

FIG. 1 illustrates a flow chart of a method for acquiring depth information of a target object according to various disclosed embodiments of the present disclosure;

FIG. 2 illustrates a schematic of an image outputted by a capturing device according to various disclosed embodiments of the present disclosure;

FIG. 3 illustrates a flow chart of another method for acquiring depth information of a target object according to various disclosed embodiments of the present disclosure;

FIG. 4 illustrates a schematic of an image and a grayscale image outputted by a capturing device according to various disclosed embodiments of the present disclosure;

FIG. 5 illustrates a schematic of another image and another grayscale image outputted by a capturing device according to various disclosed embodiments of the present disclosure;

FIG. 6 illustrates a flow chart of another method for acquiring target object depth information according to various disclosed embodiments of the present disclosure;

FIG. 7 illustrates a schematic of a grayscale image according to various disclosed embodiments of the present disclosure;

FIG. 8 illustrates a schematic of a grayscale image and a depth image according to various disclosed embodiments of the present disclosure;

FIG. 9 illustrates a schematic of another grayscale image and another depth image according to various disclosed embodiments of the present disclosure;

FIG. 10 illustrates a flow chart of another method for acquiring target object depth information according to various disclosed embodiments of the present disclosure;

FIG. 11 illustrates a flow chart of another method for acquiring target object depth information according to various disclosed embodiments of the present disclosure;

FIG. 12 illustrates a schematic of an image and a depth image outputted by a capturing device according to various disclosed embodiments of the present disclosure; and

FIG. 13 illustrates a structural schematic of a movable platform according to various disclosed embodiments of the present disclosure.

### DETAILED DESCRIPTION OF THE EMBODIMENTS

The technical solutions in the embodiments of the present disclosure are clearly and completely described in the following with reference to the accompanying drawings in the embodiments of the present disclosure. It is obvious that the described embodiments are merely a portion of the embodiments of the present disclosure, but not all embodiments. All other embodiments, based on the embodiments of the present disclosure, obtained by those skilled in the art without creative efforts are within the scope of the present disclosure. Moreover, in the case of no conflict, the following embodiments and features of the embodiments may be combined with each other.

The terminology used herein is merely for the purpose of describing particular embodiments and is not intended to limit the disclosure. The singular forms “a”, “the” and “such” used in present disclosure and in the claims are intended to include the plural forms as well, unless the context clearly indicates other meanings. It should be understood that the term “and/or” as used herein refers to any or all possible combinations that include one or more of associated listed items.

Although the terms first, second, third, and the like may be used in the present disclosure to describe various information, the information should not be limited to these terms. These terms are used to distinguish the same type of information from each other. For example, without departing from the scope of the present disclosure, the first information may also be referred to as the second information, and similarly, the second information may also be referred to as the first information, which may depend on the context. Moreover, the word “if” can be interpreted as “at . . . ”, or “when . . . ”, or “response determination”.

The embodiments of the present disclosure provide a method for acquiring depth information of a target object and a movable platform. The movable platform may include, but not limited to, an unmanned aerial vehicle, an unmanned ship, a ground robot (e.g., an unmanned vehicle and the like). The movable platform may track a target object, for example, a movable target object including a person, a car and the like. The movable platform may include a capturing device. The capturing device (e.g., a camera, a camcorder and the like) may be configured at a body of the movable platform. The movable platform may capture images of the target object through the capturing device, and then obtain the location information of the target object based on the image analysis of the target object. The movable platform may track the target object according to the location information of the target object. Optionally, the capturing device may be directly configured at the body of the movable platform. Optionally, the capturing device may be configured at the body of the movable platform through a carrying device. The carrying device may be a gimbal which may carry the capturing device to stabilize the capturing device and/or adjust a capturing posture of the capturing device.

Moreover, the movable platform may further include a depth sensor configured on the body of the movable platform. The depth sensor may be any sensor capable of directly or indirectly acquiring depth images. In some cases, the depth sensor may be a sensor such as a millimeter wave radar or a laser radar. In some cases, the depth sensor may be any sensor capable of acquiring depth images or grayscale images corresponding to the depth images. For example, the depth sensor may include a sensor such as a binocular camera, a monocular camera, a time-of-flight (TOF) camera, and the like.

The process of the method for acquiring the depth information of the target object according to the embodiments of the present disclosure may be further described hereinafter.

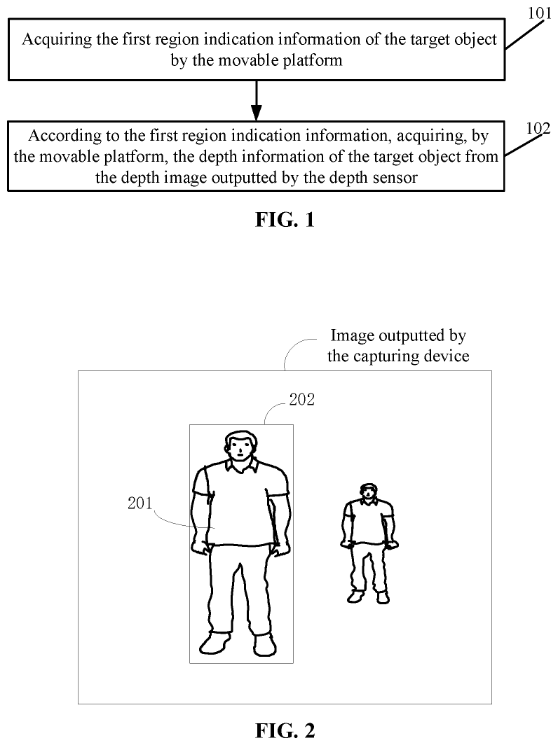

Referring to FIG. 1, FIG. 1 illustrates a flow chart of the method for acquiring the depth information of the target object according to various disclosed embodiments of the present disclosure. As shown in FIG. 1, the method for acquiring the depth information of the target object may include steps 101-102.

At 101, the movable platform may acquire first region indication information of the target object.

The first region indication information may be configured to indicate an image region of the target object in an image outputted by the capturing device. For example, FIG. 2 is the image outputted by the capturing device of the movable platform. In FIG. 2, 201 may be the target object, and the region shown by 202 may be the image region of the target object in the image outputted by the capturing device. The first region indication information may be configured to indicate the image region shown by 202.

Optionally, the first region indication information may be bounding box information of the target object. The first region indication information may be locations of an upper left corner and a lower right corner of the image region 202 in the image. The first region indication information may be configured to indicate the location of the image region of the target object in the image. The first region indication information may be configured to indicate a size of the image region of the target object in the image, such as a length and a width of the bounding box.

Optionally, in one embodiment, acquiring the first region indication information of the target object by the movable platform may be inputting the image captured by the capturing device into a first preset neural network and acquiring the first region indication information outputted by the first preset neural network by the movable platform. For example, a processor of the movable platform may acquire the image captured by the capturing device and input the image into a trained first neural network. The trained first neural network may identify objects of a specific type. If the type of the target object is consistent with the specific type, the first neural network model may identify the target object in the image and output the first region indication information of the target object; and the processor of the movable platform may acquire the first region indication information of the target object.

Optionally, in one embodiment, acquiring the first region indication information of the target object by the movable platform may be acquiring the first region indication information transmitted from a control terminal by the movable platform. The first region indication information may be determined by detecting the target object selection operation of an interactive interface displaying the images by a user. The control terminal may receive images captured by the capturing device and transmitted by the movable platform. The control terminal may be one or more of a mobile phone, a tablet computer, a remote control, and a wearable device (a watch or a bracelet). The interactive interface of the control terminal may display images captured by the capturing device of the movable platform. The user may perform the target object selection operation at the interactive interface displaying the images. For example, the target object may be selected in the bounding box; the terminal control may detect the target object selection operation by the user; and the terminal control may be configured to indicate the first region indication information of the image region of the target object according to detected operations, and may further be configured to transmit the first region indication information to the movable platform.

At 102, the movable platform may acquire the depth information of the target object from the depth image outputted by the depth sensor according to the first region indication information.

For example, the processor of the movable platform may acquire the depth image outputted by the depth sensor, and the depth image may include the depth information of the target object. Each pixel value in the depth image may be a depth between the depth sensor and the object, that is, the depth image may include the depth between the depth sensor and the target object. The processor of the movable platform may acquire the depth information of the target object from the depth image according the first region indication information.

In one embodiment, the movable platform may determine the location information of the target object according to the depth information of the target object and may track the target object according to the location information of the target object.

In the existing technology, the location information of the target object may be determined according to the bounding box information of the target object, which may result in inaccurately determining the location information of the target object. In one embodiment of the present disclosure, after acquiring the depth information of the target object, the location information of the target object may be determined according to the depth information of the target object. For example, the depth information of the target object and the first region indication information of the target object may be used to determine the location information of the target object, thereby more accurately determining the location information of the target object.

By implementing the method described in FIG. 1, the movable platform may acquire the first region indication information of the target object, and further acquire the depth information of the target object from the depth image outputted by the depth sensor according to the first region indication information. It can be seen that by implementing the method described in FIG. 1, the movable platform may determine the depth information of the target object.

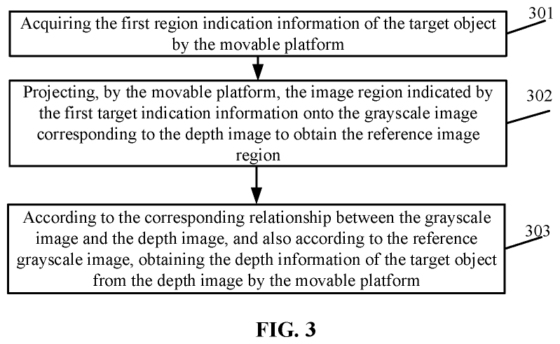

Referring to FIG. 3, FIG. 3 illustrates a flow chart of another method for acquiring the depth information of the target object according to various disclosed embodiments of the present disclosure, where 302 and 303 are implementations of 102. As shown in FIG. 3, the method for acquiring the depth information of the target object may include steps 301-303.

At 301, the movable platform may acquire the first region indication information of the target object.

The implementation of 301 may be same as the implementation of 101, which may refer to the corresponding description of 101 and may not be described in detail herein.

At 302, the movable platform may project the image region indicated by the first target indication information onto the grayscale image corresponding to the depth image to obtain a reference image region, where the grayscale image may be outputted by the depth sensor.

As mentioned above, the depth sensor may include any sensor capable of acquiring the depth image and the grayscale image corresponding to the depth image. For example, the depth sensor may include a sensor such as a binocular camera, a monocular camera, a time-of-flight (TOF) camera, and the like. In some cases, the depth sensor may first output the grayscale image and then output the depth image according to the grayscale image. In some cases, the depth sensor may first output the depth image and then output the grayscale image according to the depth image.

Each pixel point in the grayscale image may have a one-to-one corresponding relationship with each pixel point in the depth image, that is, the position of each pixel point of the depth image on the grayscale image may be same as the position of each pixel point of the grayscale image on the depth image.

Since the capturing device and the depth sensor may both be configured on the body of the movable platform, according to the spatial position relationship between the capturing device, the depth sensor and the aircraft body, the image region indicated by the first target region information may be projected onto the grayscale image corresponding to the depth image to obtain the reference image region, that is, an image region in the grayscale image. It may be understood that the reference image region may be a projection region obtained by projecting the image region indicated by the first target region information onto the grayscale image corresponding to the depth image. In some cases, the reference image region may be a determined image region according to the obtained projection region by projecting the image region onto the grayscale image corresponding to the depth image. For example, the reference image region may be the obtained image region by enlarging the obtained projection region by a preset magnification according to a preset manner.

Optionally, according to the geometric position relationship between the attitude information of the gimbal carrying the capturing device, the attitude information of the body, the depth sensor and an inertial measurement unit (IMU) of the movable platform, and also the geometric position relationship between the gimbal and the inertial measurement unit, the image region indicated by the first target region information may be projected onto the grayscale image corresponding to the depth image to obtain the reference image region.

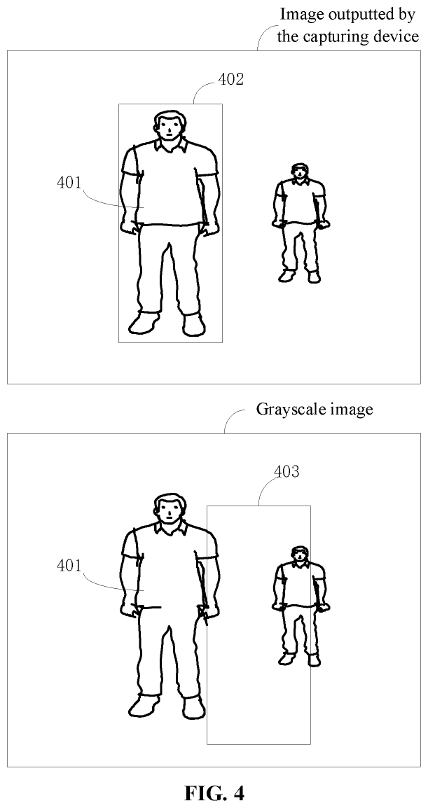

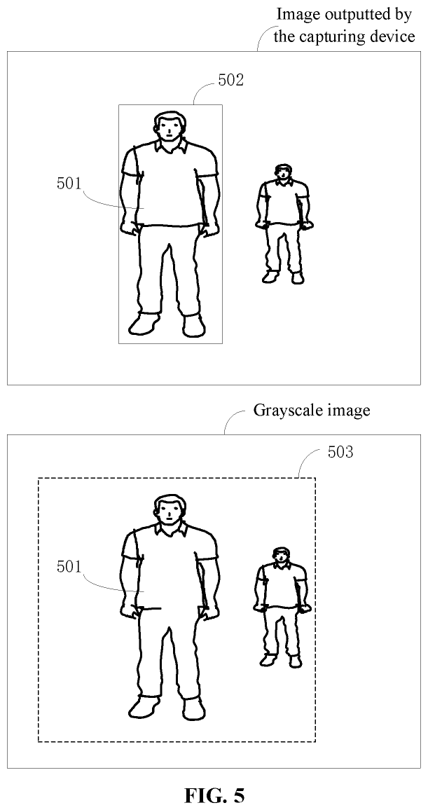

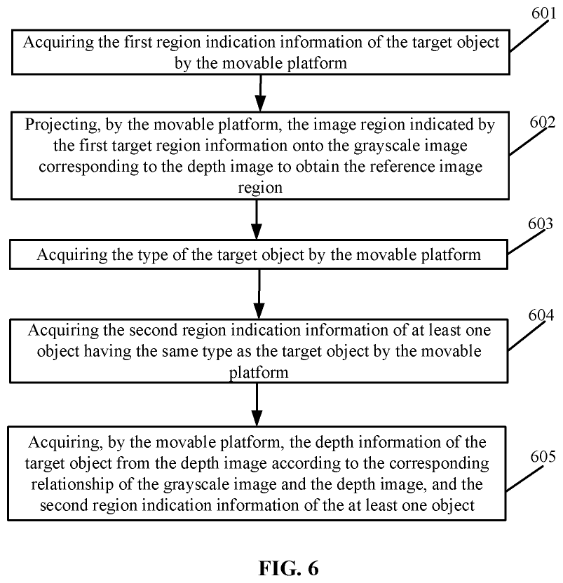

Since errors may be existed in the projection process, the projection region of the image region indicated by the first target region information onto the grayscale image may not be the region of the target object in the grayscale image. For example, as shown in FIG. 4, a person 401 is the target object; the image region indicated by the first target region information of the person 401 may be an image region 402; and an image region 403 may be the projection region of the image region 402 indicated by the first target region information onto the grayscale image. As shown in FIG. 4, the projection region 403 may be shifted downward and rightward compared to the image region 402. The projection region 403 may not accurately include the target object, which may result in the inability of accurately obtaining the depth information of the target object according to the grayscale image in the projection region. Therefore, optionally, the reference image region may be acquired according to the obtained projection region 403. For example, keeping a center of the projection region unchanged, the projection region may be appropriately enlarged to obtain the reference image region. For example, as shown in FIG. 5, the image region indicated by the first target region information is 350*250, and the reference image region 503 by enlarging the projection region is 640*360.

At 303, the movable platform may obtain the depth information of the target object from the depth image according to the corresponding relationship between the grayscale image and the depth image, and also according to the reference grayscale image.

In the embodiments of the present disclosure, after obtaining the reference image region, the movable platform may obtain the depth information of the target object from the depth image according to the corresponding relationship between the grayscale image and the depth image, and also according to the reference grayscale image.

In one embodiment, the movable platform may also determine the location information of the target object according to the depth information of the target object and track the target object according to the location information of the target object.

Determining the location information of the target object according to the depth information of the target object may accurately determine the location information of the target object. Obviously, the location information of the target object may also be determined by combining the depth information of the target object and the first region indication information of the target object, thereby more accurately determining the location information of the target object.

It may be seen that, by implementing the method described in FIG. 3, the depth information of the target object may be accurately determined.

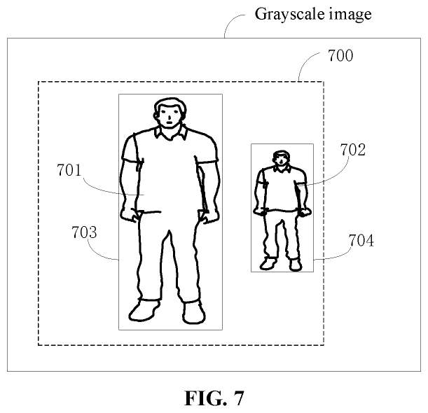

Referring to FIG. 6, FIG. 6 illustrates a flow chart of another method for acquiring the depth information of the target object according to various disclosed embodiments of the present disclosure, where 604 and 605 are implementation manners of 303. As shown in FIG. 6, the method for acquiring the depth information of the target object may include steps 601-605.

At 601, the movable platform may acquire the first region indication information of the target object.

At 602, the movable platform may project the image region indicated by the first target region information onto the grayscale image corresponding to the depth image to obtain the reference image region, where the grayscale image may be outputted by the depth sensor.

The implementation manners of 601 and 602 may be same as the implementation manners of 301 and 302, which may refer to the corresponding description of 301 and 302 and may not be described in detail herein.

At 603, the movable platform may acquire the type of the target object.

At 604, the movable platform may acquire second region indication information of at least one object having a same type as the target object, where the second region indication information may be configured to indicate the image region of the at least one object in the reference grayscale image, and the at least one object may include the target object.

At 605, the movable platform may acquire the depth information of the target object from the depth image according to the corresponding relationship of the grayscale image and the depth image, and the second region indication information of the at least one object.

In the embodiments of the present disclosure, the movable platform may acquire the type of the target object in the two following methods.

Method 1: the movable platform may input the image outputted by the capturing device into a second preset neural network (e.g., a convolutional neural network), and acquire the type of the target object outputted by the second preset neural network, that is, the movable platform may obtain the type of the target object through deep learning; for example, the processor of the movable platform may acquire the image captured by the capturing device, and input the image into a trained second neural network, where the trained second neural network may identify the type of the object in the image and output an identified type of the target object; and the processor of the movable platform may acquire the type of the target object outputted by the second neural network.

Method 2: the movable platform may acquire the type of the target object transmitted by the control terminal of the movable platform; optionally, the type of the target object may be a type inputted by the user and received by the control terminal; or the movable platform may acquire the type of the target object through other methods, which may not be limited in the embodiments of the present disclosure.

In the embodiments of the present disclosure, the movable platform may determine at least one object having the same type as the target object from the reference grayscale image, that is, may acquire at least one object having the same type as the target object from the reference grayscale image and further acquire the second region indication information of the object having the same type as the target object. As shown in FIG. 7, the type of the target object may be human. The movable platform may determine a person 701 and a person 702 as the objects having the same type as the target object from the reference grayscale image of a reference image region 700. For example, a deep learning algorithm may be used to determine the person 701 and the person 702 as the objects having the same type as the target object. The second region indication information of the person 701 may indicate the grayscale image region shown in 703, and the second region indication information of the person 702 may indicate the grayscale image region shown in 704. The movable platform may acquire the depth information of the target object from the depth image according to the corresponding relationship between the grayscale image and the depth image, the second region indication information of the person 701, and the second region indication information of the person 702.

Optionally, the second region indication information of the object may be the bounding box information of the object.

It may be seen that the depth information of the target object may be accurately acquired through the method described in FIG. 6.

As an optional implementation manner, the implementation manner of step 605 may include the following steps (11)-(13).

At (11), the movable platform may determine the second region indication information of the target object from the second region indication information of at least one object;

At (12), the movable platform may determine third region indication information of the target object according to the corresponding relationship of the grayscale image and the depth image, and the second region indication information of the target object, where the third region indication information may be used to indicate the image region of the target object on the depth image; and

At (13), the movable platform may acquire the depth information of the target object from the depth image according to the third region indication information.

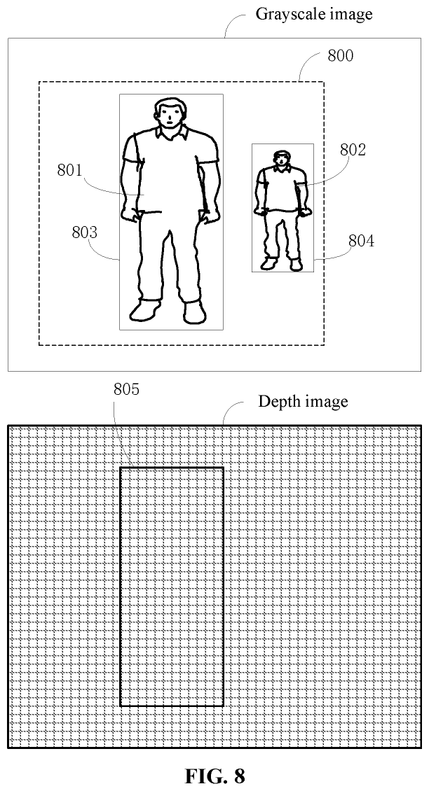

For example, as shown in FIG. 8, the movable platform may acquire at least one object, which includes a person 801 and a person 802, having the same type as the target object from the reference grayscale image of the reference image region 800. The second region indication information of the person 801 may include the region shown by 803, and the second region indication information of the person 802 may include the region shown by 804. The movable platform may determine the second region indication information of the person 801 as the second region indication information of the target object. Since the grayscale image has the corresponding relationship with the depth image, the movable platform may determine the third region indication information of the person 801 according to the corresponding relationship between the grayscale image and the depth image, and the second region indication information of the person 801. The depth image region indicated by the third region indication information of the person 801 may correspond to the grayscale image region indicated by the second region indication information of the person 801. As shown in FIG. 8, the region shown by 805 may correspond to the grayscale image region indicated by the third region indication information of the person 801. The movable platform may acquire the depth information of the target object from the depth image according to the region indicated by the third region indication information of the person 801. By implementing one embodiment, the depth information of the target object may be accurately acquired.

Optionally, in one embodiment, acquiring the depth information of the target object from the depth image according to the third region indication information by the movable platform may be the following: performing a clustering operation on the depth image in the image region indicated by the third region indication information according to a preset manner; and determining the depth information acquired by the clustering operation as the depth information of the target object. For example, the clustering operation may be performed using the center pixel point in the image region indicated by the third region indication information as a starting point, and the depth information acquired by the clustering operation may be determined as the depth information of the target object. The clustering algorithm may determine pixels of the same type, that is, the clustering algorithm may distinguish the target object from the background, then obtain the depth image region only belonging to the target object and determine the depth information of the target object according to the depth image region of the target object. By implementing one embodiment, depth extraction may be performed on the image region indicated by the third region indication information, thereby accurately acquiring the depth information of the target object.

Optionally, the second region indication information of the at least one object may include the second region indication information of a plurality of objects. At step (11), the implementation manner of determining, by the movable platform, the second region indication information of the target object from the second region indication information of the at least one object may the following: determining an evaluation parameter of the second target information of each object in the at least one object, and determining the second region indication information of the object that the evaluation parameter meets a preset requirement as the second region indication information of the target object.

For example, the movable platform may determine the evaluation parameter of the second target information of each object in the at least one object. The evaluation parameter of the second target information of each object may be analyzed to determine the second target indication information of a determined target object in the second target information of the at least one object according to the evaluation parameter. By implementing one embodiment, the second region indication information of the target object may be determined from the second region information of the plurality of objects.

Optionally, the evaluation parameter may include a distance between the image region and the reference image region indicated by the second region indication information. The implementing manner of determining the second region indication information of the object that the evaluation parameter meets the preset requirement as the second region indication information of the target object may be determining the second region indication information of the object with a minimum distance as the second region indication information of the target object. For example, the distance may be a distance between a center position of the image region indicated by the second region indication information and a center position of the reference image region. For example, as shown in FIG. 8, the distance between the center position of the image region 803 indicated by the second region indication information and the center position of the reference image region 800 may be minimum, so the person 801 may be determined as the target object, and the second region indication information of the image region 803 may be determined as the second region indication information of the target object. By implementing one embodiment, the second region indication information of the target object may be accurately determined from the second region indication information of the plurality of objects.

Or, the evaluation parameter may be other parameters, which may not be limited in the embodiments of the present disclosure.

In one embodiment, the implementation manner of step 605 may include the following steps (21)-(23).

At (21), the movable platform may determine the third region indication information of the at least one object according to the corresponding relationship between the grayscale image and the depth image, and the second region indication information of the at least one object, where the third region indication information may be used to indicate the image region of the object in the depth image.

At (22), the movable platform may acquire the depth information of the at least one object from the third region indication information of the at least one object.

At (23), the movable platform may acquire the depth information of the target object from the depth information of the at least one object.

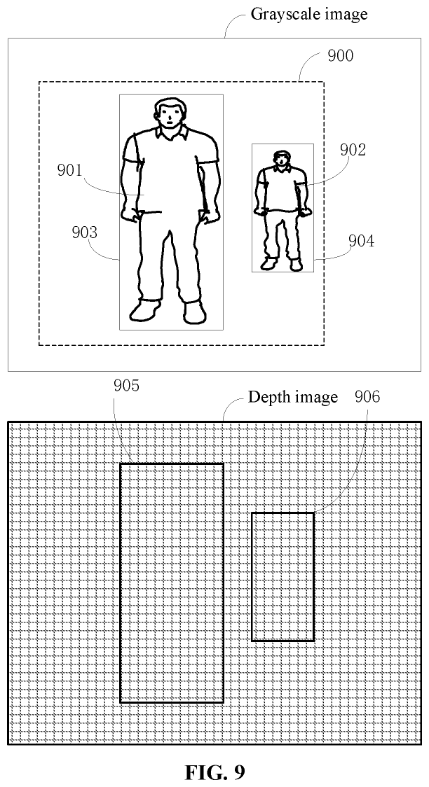

For example, as shown in FIG. 9, the movable platform may acquire at least one object, which includes a person 901 and a person 902, having the same type as the target object from the reference grayscale image of the reference image region 900. The region shown in 903 may be the region indicated by the second region indication information of the person 901, and the region shown in 904 may be the region indicated by the second region indication information of the person 902. The movable platform may determine the third region indication information of the person 901 according to the corresponding relationship between the grayscale image and the depth image, and the second region indication information of the person 901; and the movable platform may determine the third region indication information of the person 902 according to the corresponding relationship between the grayscale image and the depth image, and the second region indication information of the person 902. The third region indication information of the person 901 may indicate the region shown by 905 in the depth image, and the third region indication information of the person 902 may indicate the region shown by 906 in the depth image. The movable platform may acquire the depth information of the person 901 from the depth image according to the third region indication information of the person 901. The movable platform may acquire the depth information of the person 902 from the depth image according to the third region indication information of the person 902. The movable platform may acquire the depth information of the target object from the depth information of the person 901 and the depth information of the person 902.

By implementing one embodiment, the depth information of the target object may be accurately acquired.

In one embodiment, the implementation manner of acquiring the depth information of the at least one object from the depth image, by the movable platform, according to the third region indication information of the at least one object may be the following: performing the clustering operation on the depth image in the image region indicated by the third region indication information of a first object according to the preset manner; and determining the depth information acquired by the clustering operation as the depth information of the first object, where the first object may be any object in the at least one object.

For example, as shown in FIG. 9, the at least one object may include a person 901 and a person 902. The movable platform may perform the clustering operation on the depth image in the image region indicated by the third region indication information of the person 901 according the preset manner and determine the depth information acquired by the clustering operation as the depth information of the person 901. The movable platform may perform the clustering operation on the depth image in the image region indicated by the third region indication information of the person 902 according the preset manner and determine the depth information acquired by the clustering operation as the depth information of the person 902. For example, the clustering operation may be performed using the center pixel point in the image region indicated by the third region indication information as a starting point, and the depth information acquired by the clustering operation may be determined as the depth information of the target object. By implementing one embodiment, depth extraction may be performed on the image region indicated by the third region indication information, thereby accurately acquiring the depth information of the at least one object.

In one embodiment, the depth information of the at least one object may include the depth information of the plurality of objects. The implementation manner of acquiring the depth information of the target object from the depth information of the at least one object by the movable platform may be following: acquiring the evaluation parameter of the depth information of each object in the at least one object by the movable platform; and determining the depth information of the object that the evaluation parameter meets the preset requirement as the depth information of the target object by the movable platform.

For example, the movable platform may determine the evaluation parameter of the depth information of each object in the at least one object. The evaluation parameter of the depth information of each object may be analyzed to determine the depth information of the determined target object from the depth information of the at least one object according to the evaluation parameter. By implementing one embodiment, the depth information of the target object may be accurately determined from the depth information of the plurality of objects.

Optionally, the evaluation parameter may include the distance between the image region indicated by the second region indication information and the reference image region and/or the difference between the depth information of the object and the depth information of the target object obtained at a historical time. The implementation manner of determining the depth information of the object that the evaluation parameter meets the preset requirement as the depth information of the target object may be determining the depth information of the object with the minimum distance and/or a minimum difference as the depth information of the target object. For example, the minimum distance may be the distance between the center position of the image region indicated by the second region indication information and the center position of the reference image region.

For example, as shown in FIG. 9, the distance between the center position of the image region 903 indicated by the second region indication information and the center position of the reference image region 900 may be minimum, so the depth information of the person 901 may be determined to the depth information of the target object.

For another example, the acquired depth information of the target object is 2 m, the acquired depth information of the person 901 is 2.5 m and the acquired depth information of the person 902 is 5 m at last time, so the depth information of the person 901 may be determined as the depth information of the target object. The movable platform may detect the depth information of the target object periodically, and the period may be a short duration. The depth information of the target object may not change significantly in the short duration. Therefore, the depth information of the object with the minimum depth information difference between the object and the obtained target object in the historical time may be determined as the depth information of the target object.

It may be seen that, by implementing one embodiment, the depth information of the target object may be determined from the depth information of the plurality of objects.

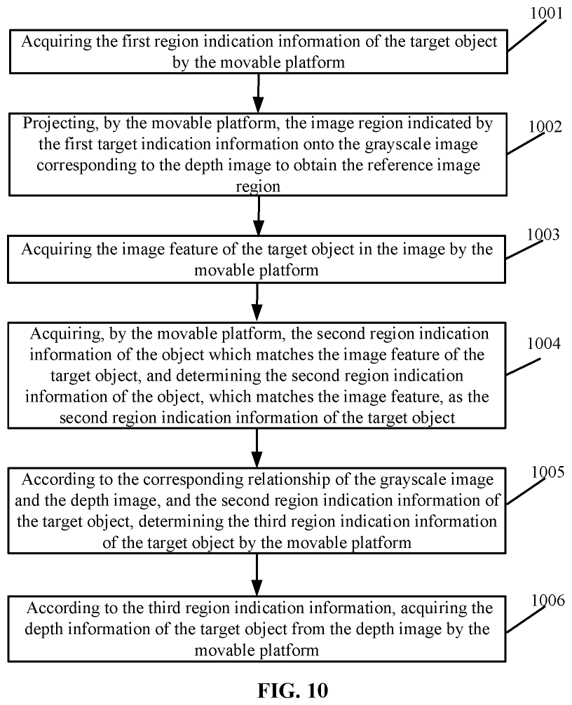

Referring to FIG. 10, FIG. 10 illustrates a flow chart of another method for acquiring the depth information of the target object according to various disclosed embodiments of the present disclosure, where 1004 and 1006 are implementation manners of 303. As shown in FIG. 10, the method for acquiring the depth information of the target object may include steps 1001-1006.

At 1001, the movable platform may acquire the first region indication information of the target object.

At 1002, the movable platform may project the image region indicated by the first target indication information onto the grayscale image corresponding to the depth image to obtain the reference image region, where the grayscale image may be outputted by the depth sensor.

The implementation of 1001 and 1002 may be same as the implementation of 301 and 302, which may refer to the corresponding description of 301 and 302 and may not be described in detail herein.

At 1003, the movable platform may acquire the image feature of the target object in the image.

In the embodiments of the present disclosure, the movable platform may acquire the image feature of the target object in the following two methods.

Method 1: the movable platform may input the image outputted by the capturing device into a third preset neural network (e.g., a convolutional neural network), and acquire the image feature of the target object outputted by the third preset neural network, that is, the movable platform may obtain the image feature of the target object through deep learning; for example, the processor of the movable platform may acquire the image captured by the capturing device, and input the image into a trained third neural network, where the trained third neural network may identify the image feature of the object of a specific type; if the type of the target object is consistent with the specific type, the first neural network model may identify the image feature of the target object and output the image feature of the target object, and the processor of the movable platform may acquire the outputted image feature of the target object.

Method 2: the movable platform may acquire the image feature of the target object transmitted by the control terminal of the movable platform; optionally, the image feature of the target object may be inputted by the user on the control terminal; for example, the user may input the image feature of the target object, which may be identified by the control terminal, on the control terminal, and the control terminal may transmit the image feature of the target object inputted by the user to the movable platform; or the movable platform may acquire the image feature of the target object through other manners, which may not be limited in the embodiments of the present disclosure.

At 1004, the movable platform may acquire the second region indication information of the object which matches the image feature of the target object and determine the second region indication information of the object which matches the image feature as the second region indication information of the target object. The second region indication information may be used to indicate the image region of the object which matches the image feature in the reference grayscale image.

At 1005, the movable platform may determine the third region indication information of the target object according to the corresponding relationship of the grayscale image and the depth image, and the second region indication information of the target object. The third region indication information may be used to indicate the image region of the target object in the depth image.

At 1006, the movable platform may acquire the depth information of the target object from the depth image according to the third region indication information.

That is, the movable platform may determine the object which matches the image feature of the target object from the reference grayscale image and may further acquire the second region indication information of the object which matches the image feature of the target object. For example, as shown in FIG. 8, the movable platform may determine the person 801 as the object which matches the image feature of the target object in the reference grayscale image of the image region 800, so the movable platform may determine the second region indication information of the person 801 as the second region indication information of the target object. The second region indication information of the target object may indicate the image region 803. The movable platform may determine the third region indication information of the target object according to the corresponding relationship between the grayscale image and the depth image, and the second region indication information of the target object. The third region indication information of the target object may indicate the region 805 in the depth image. The movable platform may acquire the depth information of the target object from the depth image according to the third region indication information.

Optionally, the implementation manner of acquiring the depth information of the target object from the depth image according to the third region indication information by the movable platform may be: performing the clustering operation on the depth image in the image region indicated by the third region indication information according to the preset manner; and determining the depth information acquired by the clustering operation as the depth information of the target object. The implementation of one embodiment may refer to the corresponding description in the embodiments in FIG. 6, which may not be described in detail herein.

It may be seen that the depth information of the target object may be accurately acquired through the method described in FIG. 10.

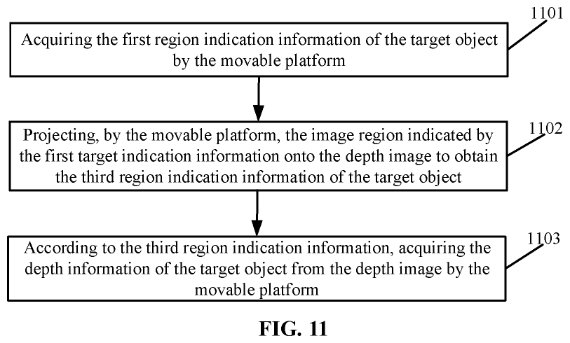

Referring to FIG. 11, FIG. 11 illustrates a flow chart of another method for acquiring the depth information of the target object according to various disclosed embodiments of the present disclosure, where 1102 and 1103 are implementation manners of 102. As shown in FIG. 11, the method for acquiring the depth information of the target object may include steps 1101-1103.

At 1101, the movable platform may acquire the first region indication information of the target object.

At 1102, the movable platform may project the image region indicated by the first target indication information onto the depth image to obtain the third region indication information of the target object, where the third region indication information may be used to indicate the image region of the target object in the depth image.

At 1103, the movable platform may acquire the depth information of the target object from the depth image according to the third region indication information.

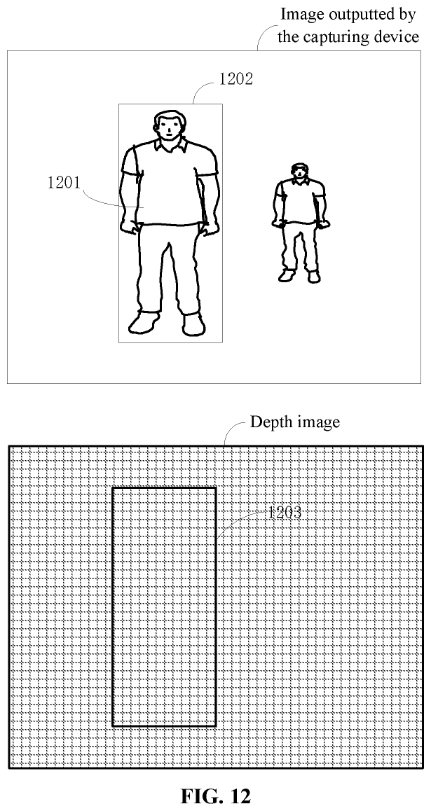

In the embodiments of the present disclosure, the movable platform may directly project the image region indicated by the first region indication information onto the depth image and determine the obtained projection region as the image region of the target object in the depth image. For example, as shown in FIG. 12, the target object may be a person 1201, and the image region indicated by the first region indication information may be the region shown by 1202. The movable platform may directly project the image region 1202 indicated by the first region indication information onto the depth image, and the obtained projection region 1203 may be the image region of the target object on the depth image, that is, the image region 1203 indicated by the third region indication information may be the region shown by 1203. The third region indication information of the target object may indicate the projection region 1203. The movable platform may acquire the depth information of the target object from the depth image indicated by the third region indication information.

In practical applications, a certain error may be existed at a joint angle of the gimbal, so the projection region, obtained by projecting the image region indicated by the first region indication information on the depth image according to the joint angle of the gimbal, may not be the image region of the target object in the depth image, that is, the projection may have a certain error. However, there may be certain cases that the joint angle of the gimbal may not have an error or have a known error. Therefore, the image region indicated by the first region indication information may be directly projected onto the depth image, and the obtained projection region may be determined as the image region of the target object on the depth image.

By implementing the method described in FIG. 11, the movable platform may accurately acquire the depth information of the target object.

In one embodiment, the implementation manner of acquiring the depth information of the target object from the depth image according to the third region indication information by the movable platform may be: performing the clustering operation on the depth image in the image region indicated by the third region indication information according to the preset manner; and determining the depth information acquired by the clustering operation as the depth information of the target object. The implementation of one embodiment may refer to the corresponding description in the embodiments in FIG. 6, which may not be described in detail herein.

In one embodiment, the implementation manner of projecting the image region indicated by the first region indication information onto the depth image to obtain the third region indication information of the target object, by configuring the capturing device on the body of the movable platform through the gimbal, may be acquiring the joint angle error of the gimbal, and projecting the image region indicated by the first region indication information onto the depth image according to the joint angle error, thereby obtaining the third region indication information of the target object.

In one embodiment, if a certain error is at the joint angle of the gimbal, the projection region, obtained by projecting the image region indicated by the first region indication information on the depth image, may not be the image region of the target object on the depth image. Therefore, the joint angle error may be first calculated, and then the measured joint angle may be corrected according to the joint angle error. Next, the image region indicated by the first region indication information may be projected on the depth image according to the corrected joint angle of the gimbal, and the projection region currently obtained may be the image region of the target object on the depth image. Furthermore, according to the geometric position relationship between the corrected joint angle of the gimbal, the attitude information of the gimbal carrying the capturing device, the attitude information of the body, the depth sensor and an inertial measurement unit (IMU) of the movable platform, and also the geometric position relationship between the gimbal and the inertial measurement unit, the image region indicated by the first target region information may be projected onto the depth image to obtain the third region indication information of the target object. It may be seen that by implementing one embodiment, the image region of the target object in the depth image may be obtained through the accurate projection.

In one embodiment, the implementation of acquiring the joint angle error of the gimbal by the movable platform may be: acquiring the image feature in the image outputted by the capturing device; acquiring the image feature in the grayscale image corresponding to the depth image, where the grayscale image may be outputted by the depth sensor; matching the image feature in the image outputted by the capturing device with the image feature in the grayscale image to acquire a first image feature in the image outputted by the capturing device and a second image feature in the corresponding grayscale image that is successfully matched with the first image feature; and acquiring the joint angle error of the gimbal according to the location information of the first image feature in the image outputted by the capturing device and the location information of the second image feature in the grayscale image. By implementing one embodiment, the joint angle error of the gimbal may be accurately calculated.

That is, in one embodiment, the depth sensor may be a sensor which may acquire the grayscale image and the depth image. When the first image feature in the image outputted by the capturing device matches the second image feature in the grayscale image outputted by the depth sensor, the movable platform may acquire the joint angle error of the gimbal according to the location information of the first image feature in the image outputted by the capturing device and the location information of the second image feature in the grayscale image.

Optionally, the movable platform may input the image outputted by the capturing device into a fourth preset neural network (e.g., a convolutional neural network), and acquire the image feature of the image outputted by the capturing device and outputted by a fourth preset neural network. Similarly, the movable platform may input the grayscale image outputted by the depth sensor into a fifth preset neural network (e.g., a convolutional neural network), and acquire the image feature of the grayscale image outputted by the depth sensor and outputted by a fifth preset neural network. Or the movable platform may acquire the image feature of the target object through other manners, which may not be limited in the embodiments of the present disclosure.

In one embodiment, after acquiring the depth information of the target object, the movable platform may also determine the location information of the target object according to the depth information of the target object and track the target object according to the location information of the target object.

Determining the location information of the target object according to the depth information of the target object may accurately determine the location information of the target object. Obviously, the location information of the target object may also be determined by combining the depth information of the target object and the first region indication information of the target object, thereby more accurately determining the location information of the target object.

The embodiments of the present disclosure provide a movable platform. The body of the movable platform may be configured with the capturing device and the depth sensor. The movable platform may at least include a processing unit.

The processing unit may be configured to acquire the first region indication information of the target object, where the first region indication information may be configured to indicate the image region of the target object in the image outputted by the capturing device.

The processing unit may be further configured to acquire the depth information of the target object from the depth image outputted by the depth sensor according to the first region indication information.

Optionally, acquiring the depth information of the target object from the depth image outputted by the depth sensor according to the first region indication information by the processing unit may include:

projecting the image region indicated by the first target indication information onto the grayscale image corresponding to the depth image to obtain the reference image region, where the grayscale image may be outputted by the depth sensor; and

acquiring the depth information of the target object from the depth image according to the corresponding relationship between the grayscale image and the depth image, and also according to the reference grayscale image, where the reference grayscale image may be grayscale image in the reference image region.

Optionally, the processing unit may be configured to acquire the type of the target object.

Acquiring the depth information of the target object from the depth image according to the corresponding relationship between the grayscale image and the depth image, and the reference grayscale image by the processing unit may include:

acquiring the second region indication information of at least one object having the same type as the target object, where the second region indication information may be configured to indicate the image region of the at least one object in the reference grayscale image, and the at least one object may include the target object; and

acquiring the depth information of the target object from the depth image according to the corresponding relationship between the grayscale image and the depth image, and the second region indication information of the at least one object.

Optionally, acquiring the depth information of the target object from the depth image according to the corresponding relationship between the grayscale image and the depth image, and the second region indication information of the at least one object by the processing unit may include:

determining the second region indication information of the target object from the second region indication information of the at least one object;

determining the third region indication information according to the corresponding relationship and the second region indication information of the target object, where the third region indication information may be used to indicate the image region of the target object on the depth image; and

acquiring the depth information of the target object from the depth image according to the third region indication information.

Optionally, the second region indication information of the at least one object may include the second region indication information of the plurality of objects.

Determining the second region indication information of the target object from the second region indication information of the at least one object by the processing unit may include:

determining the evaluation parameter of the second target information of each object; and

determining the second region indication information of the object that the evaluation parameter meets the preset requirement as the second region indication information of the target object.

Optionally, the evaluation parameter may include the distance between the image region indicated by the second region indication information and the reference image region.

Determining the second region indication information of the object that the evaluation parameter meets the preset requirement as the second region indication information of the target object by the processing unit may include:

determining the second region indication information of the object with a minimum distance as the second region indication information of the target object.

Optionally, acquiring the depth information of the target object from the depth image according to the corresponding relationship between the grayscale image and the depth image, and the second region indication information of the at least one object by the processing unit may include:

determining the third region indication information of the at least one object according to the corresponding relationship between the grayscale image and the depth image, and the second region indication information of the at least one object, where the third region indication information may be used to indicate the image region of the object on the depth image;

acquiring the depth information of the at least one object from the third region indication information of the at least one object; and

acquiring the depth information of the target object from the depth information of the at least one object.

Optionally, the depth information of the at least one object may include the depth information of the plurality of objects.

Acquiring the depth information of the target object from the depth information of the at least one object by the processing unit may include:

acquiring the evaluation parameter of the depth information of each object in the at least one object; and

determining the depth information of the object that the evaluation parameter meets the preset requirement as the depth information of the target object.

Optionally, the evaluation parameter may include the distance between the image region indicated by the second region indication information and the reference image region and/or the difference between the depth information of the object and the depth information of the target object obtained at a historical time.

Determining the depth information of the object that the evaluation parameter meets the preset requirement as the depth information of the target object by the processing unit may include:

determining the depth information of the object with the minimum distance and/or the minimum difference as the depth information of the target object.

Optionally, the processing unit is configured to acquire the image feature of the target object in the image.

Acquiring the depth information of the target object from the depth image according to the corresponding relationship between the grayscale image and the depth image, and the reference grayscale image by the processing unit may include:

acquiring the second region indication information of the object which matches the image feature of the target object and determining the second region indication information of the object which matches the image feature as the second region indication information of the target object, where the second region indication information may be used to indicate the image region of the object which matches the image feature in the reference grayscale image;

determining the third region indication information according to the corresponding relationship and the second region indication information of the target object, where the third region indication information may be used to indicate the image region of the target object in the depth image; and

acquiring the depth information of the target object from the depth image according to the third region indication information.

Optionally, acquiring the depth information of the target object from the depth image outputted by the depth sensor according to the first region indication information by the processing unit may include:

projecting the image region indicated by the first target indication information onto the depth image to obtain the third region indication information of the target object, where the third region indication information may be used to indicate the image region of the target object in the depth image; and

acquiring the depth information of the target object from the depth image according to the third region indication information.

Optionally, the capturing device may be configured on the body of the movable platform through the gimbal.

Projecting the image region indicated by the first region indication information onto the depth image to obtain the third region indication information of the target object by the processing unit may include:

acquiring the joint angle error of the gimbal; and

projecting the image region indicated by the first region indication information onto the depth image according to the joint angle error, thereby obtaining the third region indication information of the target object.

Optionally, acquiring the joint angle error of the gimbal by the processing unit may include:

acquiring the image feature in the image outputted by the capturing device;

acquiring the image feature in the grayscale image corresponding to the depth image, where the grayscale image may be outputted by the depth sensor;

matching the image feature in the image outputted by the capturing device with the image feature in the grayscale image to acquire the first image feature in the image outputted by the capturing device and the second image feature in the corresponding grayscale image that is successfully matched with the first image feature; and

acquiring the joint angle error of the gimbal according to the location information of the first image feature in the image outputted by the capturing device and the location information of the second image feature in the grayscale image.

Optionally, acquiring the depth information of the target object from the depth image according to the third region indication information by the processing unit may include:

performing the clustering operation on the depth image in the image region indicated by the third region indication information according to the preset manner; and

determining the depth information acquired by the clustering operation as the depth information of the target object.

Optionally, the processing unit may be configured to determine the location information of the target object according to the depth information of the target object and track the target object according to the location information of the target object.

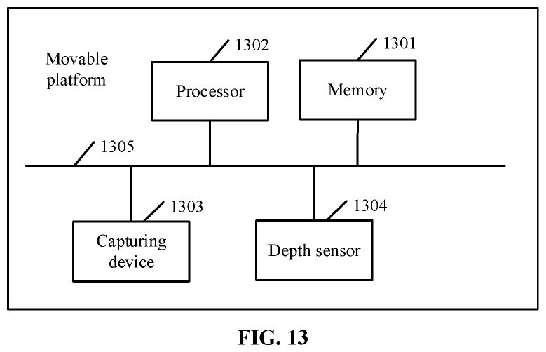

Referring FIG. 13, FIG. 13 illustrates a structural schematic of a movable platform according to various disclosed embodiments of the present disclosure. As shown in FIG. 13, the movable platform may include a memory 1301, a processor 1302, a capturing device 1303, and a depth sensor 1304. Optionally, the memory 1301, the processor 1302, the capturing device 1303, and the depth sensor 1304 may be connected through a bus system 1305.

The memory 1301 may be configured to store program instructions. The memory 1301 may include a volatile memory such as a random-access memory (RAM) and also include a non-volatile memory such as a flash memory, a solid-state drive (SSD), and may further include any combination of above-mentioned types.

The processor 1302 may include a central processing unit (CPU) and may further include a hardware chip. The above-mentioned hardware chip may be an application-specific integrated circuit (ASIC), a programmable logic device (PLD), and the like. The above-mentioned PLD may be a field-programmable gate array (FPGA), a generic array logic (GAL), and the like. The processor 1302 may call the program instructions in the memory 1301 to perform the following steps:

acquiring the first region indication information of the target object, where the first region indication information may be used to indicate the image region of the target object in the image outputted by the capturing device 1303; and

acquiring the depth information of the target object from the depth image outputted by the depth sensor 1304 according to the first region indication information.

Optionally, acquiring the depth information of the target object from the depth image outputted by the depth sensor 1304 according to the first region indication information by the processor 1302 may include:

projecting the image region indicated by the first target indication information onto the grayscale image corresponding to the depth image to obtain the reference image region, where the grayscale image may be outputted by the depth sensor 1304; and

acquiring the depth information of the target object from the depth image according to the corresponding relationship between the grayscale image and the depth image, and also according to the reference grayscale image, where the reference grayscale image may be grayscale image in the reference image region.

Optionally, the processor 1302 may be configured to call program instructions to acquire the type of the target object.

Acquiring the depth information of the target object from the depth image according to the corresponding relationship between the grayscale image and the depth image, and the reference grayscale image by the processor 1302 may include:

acquiring the second region indication information of at least one object having the same type as the target object, where the second region indication information may be configured to indicate the image region of the at least one object in the reference grayscale image, and the at least one object may include the target object; and

acquiring the depth information of the target object from the depth image according to the corresponding relationship between the grayscale image and the depth image, and the second region indication information of the at least one object.

Optionally, acquiring the depth information of the target object from the depth image according to the corresponding relationship between the grayscale image and the depth image, and the second region indication information of the at least one object by the processor 1302 may include:

determining the second region indication information of the target object from the second region indication information of the at least one object;

determining the third region indication information according to the corresponding relationship and the second region indication information of the target object, where the third region indication information may be used to indicate the image region of the target object on the depth image; and

acquiring the depth information of the target object from the depth image according to the third region indication information.

Optionally, the second region indication information of the at least one object may include the second region indication information of the plurality of objects.

Determining the second region indication information of the target object from the second region indication information of the at least one object by the processor 1302 may include:

determining the evaluation parameter of the second target information of each object; and

determining the second region indication information of the object that the evaluation parameter meets the preset requirement as the second region indication information of the target object.

Optionally, the evaluation parameter may include the distance between the image region indicated by the second region indication information and the reference image region.

Determining the second region indication information of the object that the evaluation parameter meets the preset requirement as the second region indication information of the target object by the processor 1302 may include:

determining the second region indication information of the object with the minimum distance as the second region indication information of the target object.

Optionally, acquiring the depth information of the target object from the depth image according to the corresponding relationship between the grayscale image and the depth image, and the second region indication information of the at least one object by the processor 1302 may include:

determining the third region indication information of the at least one object according to the corresponding relationship between the grayscale image and the depth image, and the second region indication information of the at least one object, where the third region indication information may be used to indicate the image region of the object on the depth image;

acquiring the depth information of the at least one object from the third region indication information of the at least one object; and

acquiring the depth information of the target object from the depth information of the at least one object.

Optionally, the depth information of the at least one object may include the depth information of the plurality of objects.

Acquiring the depth information of the target object from the depth information of the at least one object by the processor 1302 may include:

acquiring the evaluation parameter of the depth information of each object in the at least one object; and

determining the depth information of the object that the evaluation parameter meets the preset requirement as the depth information of the target object.

Optionally, the evaluation parameter may include the distance between the image region indicated by the second region indication information and the reference image region and/or the difference between the depth information of the object and the depth information of the target object obtained at a historical time.

Determining the depth information of the object that the evaluation parameter meets the preset requirement as the depth information of the target object by the processor 1302 may include:

determining the depth information of the object with the minimum distance and/or the minimum difference as the depth information of the target object.

Optionally, the processor 1302 is configured to call program instructions to acquire the image feature of the target object in the image.

Acquiring the depth information of the target object from the depth image according to the corresponding relationship between the grayscale image and the depth image, and the reference grayscale image by the processor 1302 may include:

acquiring the second region indication information of the object which matches the image feature of the target object and determining the second region indication information of the object which matches the image feature as the second region indication information of the target object, where the second region indication information may be used to indicate the image region of the object which matches the image feature in the reference grayscale image;

determining the third region indication information according to the corresponding relationship and the second region indication information of the target object, where the third region indication information may be used to indicate the image region of the target object on the depth image; and

acquiring the depth information of the target object from the depth image according to the third region indication information.

Optionally, acquiring the depth information of the target object from the depth image outputted by the depth sensor 1304 according to the first region indication information by the processor 1302 may include:

projecting the image region indicated by the first target indication information onto the depth image to obtain the third region indication information of the target object, where the third region indication information may be used to indicate the image region of the target object on the depth image; and

acquiring the depth information of the target object from the depth image according to the third region indication information.

Optionally, the capturing device 1303 may be configured on the body of the movable platform through the gimbal.

Projecting the image region indicated by the first region indication information onto the depth image to obtain the third region indication information of the target object by the processor 1302 may include:

acquiring the joint angle error of the gimbal; and

projecting the image region indicated by the first region indication information on the depth image according to the joint angle error, thereby obtaining the third region indication information of the target object.

Optionally, acquiring the joint angle error of the gimbal by the processor 1302 may include:

acquiring the image feature in the image outputted by the capturing device 1303;

acquiring the image feature in the grayscale image corresponding to the depth image, where the grayscale image may be outputted by the depth sensor;

matching the image feature in the image outputted by the capturing device and the image feature in the grayscale image to acquire a first image feature in the image outputted by the capturing device and a second image feature in the corresponding grayscale image that is successfully matched with the first image feature; and

acquiring the joint angle error of the gimbal according to the location information of the first image feature in the image outputted by the capturing device and the location information of the second image feature in the grayscale image.

Optionally, acquiring the depth information of the target object from the depth image according to the third region indication information by the processor 1302 may include:

performing the clustering operation on the depth image in the image region indicated by the third region indication information according to the preset manner; and

determining the depth information acquired by the clustering operation as the depth information of the target object.

Optionally, the processor 1302 may be configured to call program instructions to determine the location information of the target object according to the depth information of the target object and track the target object according to the location information of the target object.

Based on the same concept of the present disclosure, the principle of the movable platform to solve the problems provided in the embodiments of the present disclosure may be similar to the method embodiments of the present disclosure. Therefore, the implementation of the movable platform may refer to the implementation of the method, and the beneficial effect of the movable platform may refer to the beneficial effect of the method, which may not be described in detail for brevity.

It should be noted that, for simplicity of description, the above-mentioned method embodiments may all be described as a series of action combinations, but those skilled in the art should know that the present disclosure may not limited by the described action order. According to the present disclosure, some steps may be performed in another order or simultaneously. Those skilled in the art should also know that the embodiments described in the description are all preferred embodiments, and the actions and modules involved may not necessarily required by the present disclosure.

Those skilled in the art should know that, in one or more of the above-mentioned embodiments, the functions described in the present disclosure may be implemented by hardware, software, firmware, or any combination thereof. When implemented in software, the functions may be stored in or transmitted over as one or more instructions or code on computer-readable media. Computer-readable media may include computer storage media and communication media. The communication media may be any media that may facilitate the transfer of a computer program from one place to another. The storage media may be any available media that can be accessed by a general purpose or a special purpose computer.

The embodiments described above further describe the objectives, technical solutions, and beneficial effects of the present disclosure in detail. It should be understood that the above-mentioned embodiments may merely be specific embodiments of the present disclosure and are not intended to limit the present disclosure. The scope of protection, any modification, equivalent replacement, and improvement made on the basis of the technical solution of the present disclosure shall be included in the scope of protection of the present disclosure.

What is claimed is:

1. A method for acquiring depth information of a target object, applied to a movable platform, wherein a capturing device and a depth sensor are configured at a body of the movable platform, the method comprising:
acquiring first region indication information of the target object, wherein the first region indication information is configured to indicate an image region of the target object in an image outputted by the capturing device; and
acquiring the depth information of the target object from a depth image outputted by the depth sensor according to the first region indication information.

2. The method according to claim 1, wherein acquiring the depth information of the target object from the depth image outputted by the depth sensor according to the first region indication information includes:
projecting an image region indicated by first target indication information onto a grayscale image corresponding to the depth image to obtain a reference image region, wherein the grayscale image is outputted by the depth sensor; and
according to a corresponding relationship between the grayscale image and the depth image, and a reference grayscale image, acquiring the depth information of the target object from the depth image wherein the reference grayscale image is the grayscale image in the reference image region.

3. The method according to claim 2, further including:
acquiring a type of the target object; and
acquiring the depth information of the target object from the depth image according to the corresponding relationship between the grayscale image and the depth image, and the reference grayscale image includes:
acquiring second region indication information of at least one object having a same type as the target object, wherein the second region indication information is configured to indicate an image region of the at least one object in the reference grayscale image, and the at least one object includes the target object; and
acquiring the depth information of the target object from the depth image according to the corresponding relationship between the grayscale image and the depth image, and the second region indication information of the at least one object.

4. The method according to claim 3, wherein:
acquiring the depth information of the target object from the depth image according to the corresponding relationship between the grayscale image and the depth image, and the second region indication information of the at least one object includes:
determining the second region indication information of the target object from the second region indication information of the at least one object;
according to the corresponding relationship between the grayscale image and the depth image, and the second region indication information of the target object, determining third region indication information wherein the third region indication information is configured to indicate the image region of the target object in the depth image; and
acquiring the depth information of the target object from the depth image according to the third region indication information.

5. The method according to claim 4, wherein:
the second region indication information of the at least one object includes second region indication information of a plurality of objects; and
determining the second region indication information of the target object from the second region indication information of the at least one object includes:
determining an evaluation parameter of second region indication information of each object; and
determining second region indication information of an object, that meets a preset requirement of the evaluation parameter, as the second region indication information of the target object.

6. The method according to claim 5, wherein:
the evaluation parameter includes a distance between an image region indicated by the second region indication information and the reference image region; and
determining the second region indication information of the object, which meets the preset requirement of the evaluation parameter, as the second region indication information of the target object includes:
determining second region indication information of an object with a minimum distance as the second region indication information of the target object.

7. The method according to claim 3, wherein:
acquiring the depth information of the target object from the depth image according to the corresponding relationship between the grayscale image and the depth image, and the second region indication information of the at least one object includes:
determining third region indication information of the at least one object according to the corresponding relationship between the grayscale image and the depth image, and the second region indication information of the at least one object, wherein the third region indication information is configured to indicate an image region of an object in the depth image;
acquiring depth information of the at least one object from the third region indication information of the at least one object; and
acquiring the depth information of the target object from the depth information of the at least one object.

8. The method according to claim 7, wherein:
the depth information of the at least one object includes depth information of a plurality of objects; and
acquiring the depth information of the target object from the depth information of the at least one object includes:
acquiring an evaluation parameter of depth information of each object in the at least one object; and
determining depth information of an object, which meets a preset requirement of the evaluation parameter, as the depth information of the target object.

9. The method according to claim 8, wherein:
the evaluation parameter includes a distance between an image region indicated by the second region indication information and the reference image region and/or a difference between the depth information of the object and the depth information of the target object obtained at a historical time;
determining the depth information of the object, which meets the preset requirement of the evaluation parameter, as the depth information of the target object includes:
determining the depth information of the object with a minimum distance and/or a minimum difference as the depth information of the target object.

10. The method according to claim 2, further including:
acquiring an image feature of the target object in the image; and
acquiring the depth information of the target object from the depth image according to the corresponding relationship between the grayscale image and the depth image, and the reference grayscale image includes:
acquiring second region indication information of an object matching the image feature of the target object and determining the second region indication information of the object matching the image feature as the second region indication information of the target object, wherein the second region indication information is configured to indicate an image region of the object matching the image feature in the reference grayscale image;
determining third region indication information according to the corresponding relationship between the grayscale image and the depth image, and the second region indication information of the target object, wherein the third region indication information is configured to indicate the image region of the target object in the depth image; and
acquiring the depth information of the target object from the depth image according to the third region indication information.

11. The method according to claim 1, wherein:
acquiring the depth information of the target object from the depth image outputted by the depth sensor according to the first region indication information includes:
projecting an image region indicated by the first region indication information onto the depth image to obtain third region indication information of the target object, wherein the third region indication information is configured to indicate the image region of the target object in the depth image; and
acquiring the depth information of the target object from the depth image according to the third region indication information.

12. The method according to claim 11, wherein:
the capturing device is configured at the body of the movable platform through a gimbal; and
projecting the image region indicated by the first region indication information onto the depth image to obtain the third region indication information of the target object includes:
acquiring a joint angle error of the gimbal; and
according to the joint angle error, projecting the image region indicated by the first region indication information onto the depth image to obtain the third region indication information of the target object.

13. The method according to claim 12, wherein:
acquiring the joint angle error of the gimbal includes:
acquiring an image feature in the image outputted by the capturing device;
acquiring the image feature in the grayscale image corresponding to the depth image, wherein the grayscale image is outputted by the depth sensor;
matching the image feature in the image outputted by the capturing device with the image feature in the grayscale image to acquire a first image feature in the image outputted by the capturing device and a second image feature in a corresponding grayscale image that is successfully matched with the first image feature; and
acquiring the joint angle error of the gimbal according to location information of the first image feature in the image outputted by the capturing device and location information of the second image feature in the grayscale image.

14. The method according to claim 4, wherein:
acquiring the depth information of the target object from the depth image according to the third region indication information includes:
performing a clustering operation on the depth image in the image region indicated by the third region indication information according to a preset manner; and
determining depth information acquired by the clustering operation as the depth information of the target object.

15. The method according to claim 1, further including:
determining location information of the target object according to the depth information of the target object; and
tracking the target object according to the location information of the target object.

16. A movable platform, comprising:
a memory, a processor, a capturing device, and a depth sensor, wherein:
the memory is configured to store program instructions; and
the processor for calling the program instructions is configured to:
acquire first region indication information of a target object, wherein the first region indication information is configured to indicate an image region of the target object in an image outputted by the capturing device; and
according to the first region indication information, acquire depth information of the target object from a depth image outputted by the depth sensor.

17. The platform according to claim 16, wherein:
when acquiring the depth information of the target object from the depth image outputted by the depth sensor according to the first region indication information, the processor is further configured to:
project an image region indicated by the first target indication information onto a grayscale image corresponding to the depth image to obtain a reference image region, wherein the grayscale image is outputted by the depth sensor; and
according to a corresponding relationship between the grayscale image and the depth image, and a reference grayscale image, acquire the depth information of the target object from the depth image, wherein the reference grayscale image is the grayscale image in the reference image region.

18. The platform according to claim 17, wherein:
the processor is further configured to acquire a type of the target object; and
when acquiring the depth information of the target object from the depth image according to the corresponding relationship between the grayscale image and the depth image, and the reference grayscale image, the processor is further configured to:
acquire second region indication information of at least one object having a same type as the target object, wherein the second region indication information is configured to indicate an image region of the at least one object in the reference grayscale image, and the at least one object includes the target object; and
acquire the depth information of the target object from the depth image according to the corresponding relationship between the grayscale image and the depth image, and the second region indication information of the at least one object.

19. The platform according to 17, wherein:
the processor is further configured to acquire an image feature of the target object in the image; and
when acquiring the depth information of the target object from the depth image according to the corresponding relationship between the grayscale image and the depth image, and the reference grayscale image, the processor is configured to:
acquire second region indication information of an object matching the image feature of the target object and determining the second region indication information of the object matching the image feature as the second region indication information of the target object, wherein the second region indication information is configured to indicate an image region of the object matching the image feature in the reference grayscale image;
determine third region indication information according to the corresponding relationship between the grayscale image and the depth image, and the second region indication information of the target object, wherein the third region indication information is configured to indicate the image region of the target object in the depth image; and
acquire the depth information of the target object from the depth image according to the third region indication information.

20. The platform according to claim 16, wherein:
the processor is further configured to:
determine location information of the target object according to the depth information of the target object; and
track the target object according to the location information of the target object.
